(19) United States
(12) Patent Application Publication
(10) Pub. No.: US 2024/0170789 A1
(43) Pub. Date: May 23, 2024

(54) Battery System

(71) Applicants: Yu-Hung Li, Sunnyvale, CA (US); Edward T. Hillstrom, Vancouver (CA)

(72) Inventors: Yu-Hung Li, Sunnyvale, CA (US); Edward T. Hillstrom, Vancouver (CA)

(21) Appl. No.: 17/988,520

(22) Filed: Nov. 16, 2022

(51) Int. Cl. H01M 50/253; H01M 10/44; H01M 50/209; H01M 50/51; H02J 7/34

(52) U.S. Cl. CPC H01M 50/253; H01M 10/441; H01M 50/209; H01M 50/51; H02J 7/342; B60L 58/18; H01M 2220/20; H02J 2207/20

(57) ABSTRACT

A system includes a first group of cells having a first battery chemistry type and a second group of cells having a second battery chemistry type. Cells from the first group of cells and cells from the second group of cells are arranged in an alternating manner in a first direction of a battery pack that includes the first group of cells and the second group of cells.

### CROSS-REFERENCE TO RELATED APPLICATIONS

None.

### TECHNICAL FIELD

This disclosure relates to a battery system.

### BACKGROUND

Some battery operated systems arrange cells in a battery pack in a manner that is intended to achieve a high energy density, which can be measured as the amount of energy stored per unit volume or per unit mass. Because of heat generated by the cells during charging and discharging, thermal insulation may be required between cells, thereby decreasing the energy density of the battery pack.

### SUMMARY

A first aspect of the disclosure is a system that includes a first group of cells having a first battery chemistry type and a second group of cells having a second battery chemistry type. Cells from the first group of cells and cells from the second group of cells are arranged in an alternating manner in a first direction of a battery pack that includes the first group of cells and the second group of cells.

The battery pack may be configured such that at least one cell from the first group of cells is disposed between successive cells from the second group of cells in the first direction of the battery pack. In some implementations, each of the cells from the first group of cells and each of the cells from the second group of cells has a generally cuboidal configuration including a first end surface that faces toward a first end of the battery pack, a second end surface that faces toward a second end of the battery pack, a first side surface, a second side surface, a top surface and a bottom surface, and the first broad surfaces of the cells from the first group of cells face the second broad surfaces of adjacent ones of the cells from the second group of cells.

The cells from the first group of cells may have a lower volumetric energy density than the cells from the second group of cells. The cells from the first group of cells may have a higher initiation temperature for a thermal event than the cells from the second group of cells. The cells from the first group of cells may have a lower maximum temperature during a thermal event than the cells from the second group of cells. In some implementations, the cells from the first group of cells are lithium iron phosphate cells, and the cells from the second group of cells are at least one of nickel manganese cobalt cells or nickel cobalt aluminum oxide cells.

In some implementations, the cells from the first group of cells are electrically connected in series with the cells from the second group of cells such that each of the cells from the first group of cells is directly electrically connected to a respective cell from the second group of cells. In some implementations, the cells from the first group of cells are electrically connected in series with each other, the cells from the second group of cells are electrically connected in series with each other, and the first group of cells is not directly electrically connected to the second group of cells. In some implementations, the system further includes a DC-DC converter that is configured to transfer power between the first group of cells and the second group of cells. In some implementations, the system further includes a propulsion system that is connected to the first group of cells and to the second group of cells, wherein the second group of cells is controllable to selectively provide power to the first group of cells to charge the first group of cells using power from the second group of cells, and the second group of cells is controllable to selectively provide power to the propulsion system to cause operation of the propulsion system.

In some implementations, the battery pack includes a first group of bus bars that each electrically connect a respective pair of the cells from the first group of cells, each bus bar from the first group of bus bars extending past a respective one of the cells from the second group of cells, and a second group of bus bars that each electrically connect a respective pair of the cells from the second group of cells, each bus bar from the second group of bus bars extending past a respective one of the cells from the first group of cells.

A second aspect of the disclosure is a system that includes a battery pack having a first group of cells having a first battery chemistry type and a second group of cells having a second battery chemistry type. The system also includes a first propulsion system that is powered by the first group of cells, and a second propulsion system that is powered by the second group of cells.

In some implementations of the system according to the second aspect of the disclosure, the cells from the first group of cells and cells from the second group of cells are arranged in an alternating manner in a first direction of the battery pack. The system may include a battery housing, wherein the first group of cells is disposed in the battery housing and the second group of cells is disposed in the battery housing. In some implementations, cells from the first group of cells have a lower volumetric energy density than cells from the second group of cells. In some implementations, cells from the first group of cells are lithium iron phosphate cells, and cells from the second group of cells are at least one of nickel manganese cobalt cells or nickel cobalt aluminum oxide cells. In some implementations, the first group of cells is not electrically connected to the second group of cells.

In some implementations of the system according to the second aspect of the disclosure, the first propulsion system includes a first inverter that receives electrical power from the first group of cells and causes operation of a first electric motor using the electrical power from the first group of cells, and the second propulsion system includes a second inverter that receives electrical power from the second group of cells and causes operation of a second electric motor using the electrical power from the second group of cells.

A third aspect of the disclosure is a system that includes a first bus, a second bus, a battery pack, and a DC-DC convertor. The battery pack has a first group of cells having a first battery chemistry type, and a second group of cells having a second battery chemistry type. The first group of cells is electrically connected to the first bus, and the second group of cells is electrically connected to the second bus. The DC-DC converter is configured to transfer power between the first bus and the second bus.

In some implementations of the system according to the third aspect of the disclosure, a propulsion system is connected to the first bus. Some implementations of the system according to the third aspect of the disclosure include a controller that is configured to control the DC-DC converter and the battery pack according to a first operation mode in which electrical power is supplied to the propulsion system by the first group of cells, a second operation mode in which electrical power is supplied to the propulsion system by the second group of cells, and a third mode of operation in which electrical power is supplied to the first group of cells by the second group of cells to charge the first group of cells.

In some implementations of the system according to the third aspect of the disclosure, cells from the first group of cells and cells from the second group of cells are arranged in an alternating manner in a first direction of the battery pack. The system may also include a battery housing, wherein the first group of cells is disposed in the battery housing and the second group of cells is disposed in the battery housing. In some implementations, cells from the first group of cells have a lower volumetric energy density than cells from the second group of cells. The cells from the first group of cells may be lithium iron phosphate cells, and the cells from the second group of cells may be at least one of nickel manganese cobalt cells or nickel cobalt aluminum oxide cells.

### BRIEF DESCRIPTION OF THE DRAWINGS

FIG. 1 is an exploded view illustration of a battery pack and a housing.

FIG. 2 is a perspective view illustration of a cell of the battery pack.

FIG. 3 is a schematic diagram showing a first example of a bus bar configuration of the battery pack.

FIG. 4 is a schematic diagram showing a second example of a bus bar configuration of the battery pack.

FIGS. 5A-5F show alternative arrangements of cells in the battery pack.

FIG. 6 is a schematic diagram of a first example of a battery system that includes the battery pack.

FIG. 7 is a schematic diagram of a second example of a battery system that includes the battery pack.

### DETAILED DESCRIPTION

Some multi-cell battery packs are susceptible to thermal events in which one of the cells enters an uncontrolled self-heating state. As the amount of heat generated by a cell undergoing a thermal event increases, the heat may cause adjacent cells to also enter an uncontrolled self-heating state. Some battery chemistry types have favorable properties for thermal events, such as a higher initiation temperature at which a cell will enter the uncontrolled self-heating state, or a lower maximum temperature during the self-heating state. However, battery chemistry types with favorable properties with respect to initiation and magnitude of thermal events may have relatively lower energy densities than other battery chemistry types.

This disclosure relates to a battery system having a battery pack that includes a first group of cells and a second group of cells. The cells from the first group of cells and the cells from the second group of cells are electrochemical battery cells that have different battery chemistry types. Because they have different battery chemistry types, the first group of cells and the second group of cells may have different properties, such as different volumetric energy densities, different gravimetric energy densities, different voltages, and different rates of heat generation during charging and discharging, and different properties with respect to initiation and occurrence of thermal events.

The first group of cells and the second group of cells may be arranged in the battery pack in a manner that utilizes the differences in in the battery chemistry types to make the battery pack more tolerant of thermal events. Such configurations may improve aspects of the performance of the battery pack, such as by reducing the frequency and/or magnitude of thermal events. Such configurations may also allow for a reduction in the amount of thermal insulation provided between cells of the battery pack, as opposed to the amount of thermal insulation required for a battery pack having cells of a single battery chemistry type with high energy density, thereby reducing the volume occupied by thermal insulation within the battery pack. In particular, the configurations described herein may allow for a decrease in the percentage of the total battery pack volume that is occupied by insulation while allowing for an increase in the percentage of the total battery pack volume that is occupied by the cells of the battery pack.

The battery packs described herein may be incorporated in a battery system that is configured to supply power from the first group of cells and the second group of cells to one or more loads. As an example, the battery system may be incorporated in an electric vehicle and supply power to propulsion motors and other loads. The implementations described herein include configurations that facilitate usage of the first group of cells and the second group of cells by systems of the electric vehicle, such as a propulsion system of the electric vehicle. As one example, the first group of cells and the second group of cells may be connected in series, thereby directly combining the electrical power provided by the first group of cells and the second group of cells without additional battery system complexity. In another example, the first group of cells and the second group of cells may each supply electrical power to a separate propulsion system.

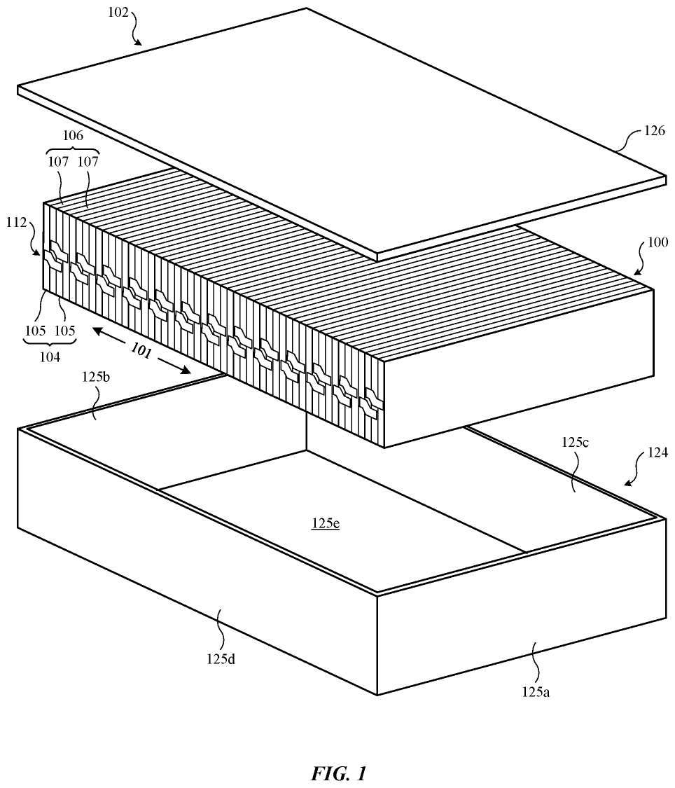

FIG. 1 is an exploded view illustration of a battery pack 100 and a housing 102. The battery pack includes a first group of cells 104, including first cells 105, and a second group of cells 106, including second cells 107, that are structurally and electrically interconnected to define the battery pack 100.

The first cells 105 all have a common battery chemistry type, which may be referred to as a first battery chemistry type. The second cells 107 all have a common battery chemistry type, which may be referred to as a second battery chemistry type. The first battery chemistry type and the second battery chemistry type are different battery chemistry types with different properties. Because of the differences between the first battery chemistry type and the second battery chemistry type, the first cells 105 and the second cells 107 have different performance characteristics.

The first battery chemistry type has a volumetric energy density and gravimetric energy density as compared to the second battery chemistry type. Thus, cells that utilize the second battery chemistry type are able to store more energy than cells of similar volume and mass that utilize the first battery chemistry type. However, the first battery chemistry type may have one or more performance characteristics that are advantageous relative to characteristics of the second battery chemistry type. The first battery chemistry type may generate less heat than the second battery chemistry type at the same rates of charging and discharging, allowing cells utilizing the first battery chemistry type to charge and discharge at higher rates than cells utilizing the second battery chemistry type. The first battery chemistry type may be less susceptible to thermal events (e.g., including an uncontrolled reaction that places a cell in a self-heating state) than the second battery chemistry type. As an example, an initiation temperature for a thermal event may be higher for the first battery chemistry type as compared to the second battery chemistry type. The first battery chemistry type may, when undergoing a thermal event, release less energy than the second battery chemistry type. As an example, a maximum temperature experienced by the first battery chemistry type during a thermal event may be lower than a maximum temperature experienced by the second battery chemistry type during a thermal event.

In one example, the first cells 105 from the first group of cells 104 utilize the first battery chemistry type, and have a lower volumetric energy density and/or a lower gravimetric energy density than the second cells 107 from the second group of cells 106, which utilize the second battery chemistry type. In another example, the first cells 105 from the first group of cells 104 utilize the first battery chemistry type, and have a higher initiation temperature for a thermal event than the second cells 107 from the second group of cells 106, which utilize the second battery chemistry type. In another example, the first cells 105 from the first group of cells 104 utilize the first battery chemistry type, and have a lower maximum temperature during a thermal event than the second cells 107 from the second group of cells 106, which utilize the second battery chemistry type.

The performance characteristics described with respect to the first battery chemistry type and the second battery chemistry type may be achieved with various different specific types of battery chemistries. In one implementation, the first cells 105 from the first group of cells 104 are lithium iron phosphate cells, and the second cells 107 from the second group of cells 106 are at least one of nickel manganese cobalt cells or nickel cobalt aluminum oxide cells. This implementation allows for favorable thermal properties through use of the lithium iron phosphate cells as the first battery chemistry type, and high energy density through use of the nickel manganese cobalt cells or nickel cobalt aluminum oxide cells as the second battery chemistry type.

To distribute heat more evenly through the battery pack 100, and to allow the battery pack 100 to benefit from the thermal performance of the first battery chemistry type, the first cells 105 from the first group of cells 104 and the second cells 107 from the second group of cells 106 are arranged in an alternating manner in a first direction 101 of the battery pack 100. Thus, for example, the battery pack 100 may be configured so that at least one of the first cells 105 from the first group of cells 104 is disposed between successive cells from the second group of cells in the first direction 101 of the battery pack 100. Similarly, the battery pack 100 may be configured so that at least one of the second cells 107 from the second group of cells 106 is disposed between successive cells from the first group of cells 104 in the first direction 101 of the battery pack 100. As another example, arrangement of cells in an alternating manner may place at least one surface of each of the first cells adjacent 105 to at least one surface from a respective one of the second cells 107.

The first direction 101 of the battery pack 100 may extend along a surface of the battery pack 100, may extend perpendicular to a surface of the battery back 100, may extend along an array of cells from the battery pack, or may extend in another direction. The first direction 101 of the battery pack 100 may correspond to a longest dimension of the battery pack 100. In some implementations, the first direction 101 of the battery pack 100 may be referred to as a longitudinal direction of the battery pack 100. When the battery pack 100 is installed in another system, the first direction 101 of the battery pack need not align with any particular direction or dimension of the system. For example, if installed in a vehicle the first direction 101 of the battery pack 100 need not be aligned with a particular direction or dimension with respect to the vehicle, such as the longitudinal direction of the vehicle.

The alternating arrangement of the first cells 105 and the second cells 107 in the battery pack 100 may be beneficial to the overall thermal performance of the battery pack 100. In the illustrated implementation, the alternating pattern of the first cells 105 and the second cells 107 places individual ones of the first cells 105 between individual ones of the second cells 107. Because of the differing thermal performance characteristics of the first cells 105 and the second cells 107, this may allow the first cells 105 to act as thermal buffers between successive ones of the second cells 107 during periods of high heat generation by the second cells 107 and/or may allow the second cells 107 to act as a thermal buffers between successive ones of the first cells 105 during periods of high heat generation by the first cells 105. In addition, if one of the second cells 107 is experiencing a thermal event, adjacent ones of the first cells 105 may be unaffected because of the higher initiation temperature for a thermal event for the first battery chemistry type. In addition, by spacing the second cells 107 from each other by interposition of the first cells 105, a thermal event may be contained within one of the second cells 107 without spreading to other ones of the second cells 107. Thus, the alternating pattern of the first cells 105 and the second cells 107 may decrease the frequency and/or magnitude of thermal events while maintaining an acceptable energy density for the battery pack 100.

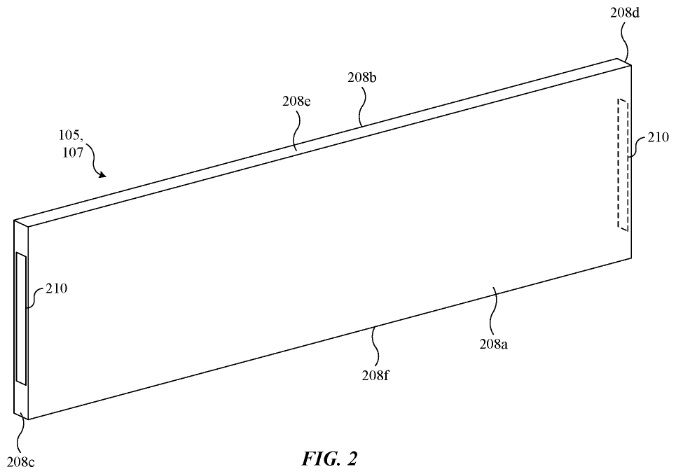

FIG. 2 is a perspective illustration showing an example of a structural and geometric configuration for the first cells 105 and the second cells 107, which may be implemented in the same way as each other except as otherwise stated herein. Each of the first cells 105 from the first group of cells 104 and each of the second cells 107 from the second group of cells 106 may have a generally cuboidal configuration including a first broad surface 208a that faces toward a first end of the battery pack 100, a second broad surface 208b that faces toward a second end of the battery pack 100, a first side surface 208c, a second side surface 208d, a top surface 208e and a bottom surface 208f. Terminals 210 (e.g., a cathode terminal and an anode terminal) may be formed on each of the first cells 105 and the second cells 107, for example, on the first side surface 208c and on the second side surface 208d of each of the first cells 105 and the second cells 107. As arranged in the battery pack 100 in an alternating arrangement of the first group of cells 104 and the second group of cells 106, for example, the first broad surfaces 208a of the first cells 105 from the first group of cells 104 face the second broad surfaces 208b of adjacent ones of the second cells 107 from the second group of cells 106.

The battery pack 100 also includes bus bars 112, which serve as electrical connections between individual cells of the battery pack 100, by electrical connection of the bus bars 112 to the terminals 210 of the first cells 105 and the second cells 107. The bus bars 112 may be conductive structures of any type. The bus bars 112 serve to interconnect the first cells 105 with each other, to interconnect the second cells 107 with each other, and/or to interconnect the first cells 105 with the second cell 107.

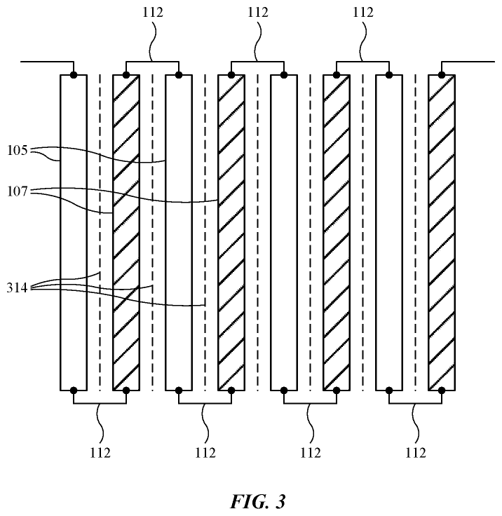

FIG. 3 is a schematic diagram showing a first example of a bus bar configuration for the bus bars 112 of the of the battery pack 100. Each of the first cells 105 is positioned between a pair of the second cells 107, and each of the second cells 107 is positioned between a pair of the first cells 105. A thermal insulation layer 314 is located between adjacent pairs of cells to control the spread of heat through the battery pack 100.

In the implementation of FIG. 3, the first cells 105 from the first group of cells 104 are electrically connected in series with the second cells 107 from the second group of cells 106 in an alternating manner. Thus, for example, each of the first cells 105 from the first group of cells 104 may be directly electrically connected to a respective cell one of the second cells 107 from the second group of cells 106. For example, each of the bus bars 112 may be connected to one of the terminals 210 of one of the first cells 105 and to one of the terminals 210 of one of the second cells 107. In this implementation, the power from provided by the first group of cells 104 and the second group of cells 106 is combined, resulting in a simpler electrical configuration, but usage of the first group of cells 104 and the second group of cells cannot be utilized separately.

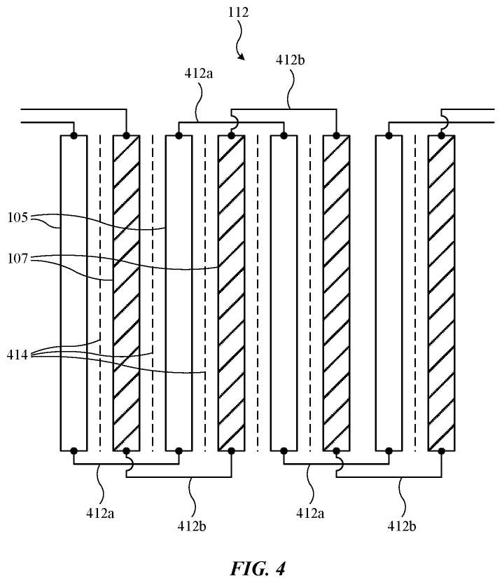

FIG. 4 is a schematic diagram showing a second example of a bus bar configuration for the bus bars 112 of the battery pack 100. Each of the first cells 105 is positioned between a pair of the second cells 107, and each of the second cells 107 is positioned between a pair of the first cells 105. A thermal insulation layer 414 is located between adjacent pairs of cells to control the spread of heat through the battery pack 100.

In the implementation shown in FIG. 4, the bus bars 112 include a first group of bus bars 412a and a second group of bus bars 412b. Using the first group of bus bars 412a and the second group of bus bars 412b, the first cells 105 from the first group of cells 104 are electrically connected in series with each other, the second cells 107 from the second group of cells 106 are electrically connected in series with each other, and the first group of cells 104 is not directly electrically connected to the second group of cells 106.

The first group of bus bars 412a includes individual bus bars that each directly electrically connect a respective pair of the first cells 105 from the first group of cells 104. Each bus bar from the first group of bus bars 412a is electrically connected to one of the terminals 210 of one of the first cells 105 and is also electrically connected to one of the terminals 210 of another one of the first cells 105. Because of the alternating configuration of the first cells 105 and the second cells 107 in the first direction 101 of the battery pack 100, each of the bus bars from the first group of bus bars 412a extends past a respective one of the second cells 107 from the second group of cells 106.

The second group of bus bars 412b includes individual bus bars that each directly electrically connect a respective pair of the second cells 107 from the second group of cells 106. Each bus bar from the second group of bus bars 412b is electrically connected to one of the terminals 210 of one of the second cells 107 and is also electrically connected to one of the terminals 210 of another one of the second cells 107. Because of the alternating configuration of the first cells 105 and the second cells 107 in the first direction 101 of the battery pack 100, each of the bus bars from the second group of bus bars 412b extends past a respective one of the first cells 105 from the first group of cells 104.

As seen in FIG. 1, the battery pack 100 is located in the housing 102. The housing 102 is a physical structure that is configured to support and contain the first group of cells 104 and the second group of cells 106 of the battery pack 100. The housing 102 may be defined by structural components, such as walls or beams, which are configured to be load bearing members that allow connection of the battery pack 100 to a system in which the battery pack 100 is implemented, and which may form part of the physical structure of the system in which the battery pack 100 is implemented. As an example, if the battery pack 100 and the housing 102 are implemented in the context of an electric vehicle, the battery pack 100 and the housing 102 may be configured as a structural battery pack that is configured to define a portion of the chassis of the electric vehicle.

In the illustrated implementation, the housing 102 includes a base portion 124 and a lid 126. The lid 126 is connectable to a top part of the base portion 124 to define an enclosed interior space of the housing 102, and the battery pack 100 is located in the enclosed interior space of the housing 102. In the illustrated implementation, the base portion 124 includes a first end wall 125a located at a first end of the housing 102, a second end wall 125b located at a second end of the housing 102, a first side wall 125c located at a first side of the housing 102 and extending from the first end wall 125a to the second end wall 125b, a second side wall 125d located at a second side of the housing 102 and extending from the first end wall 125a to the second end wall 125b, and a floor 125e located within a periphery defined by the first end wall 125a, the second end wall 125b, the first side wall 125c, and the second side wall 125d. The floor 125e is elevationally spaced from the lid 126 to define the enclosed interior space of the housing 102 between them. The housing 102 may include additional components, such as cooling features, cell monitoring circuits, battery management circuits, and other components.

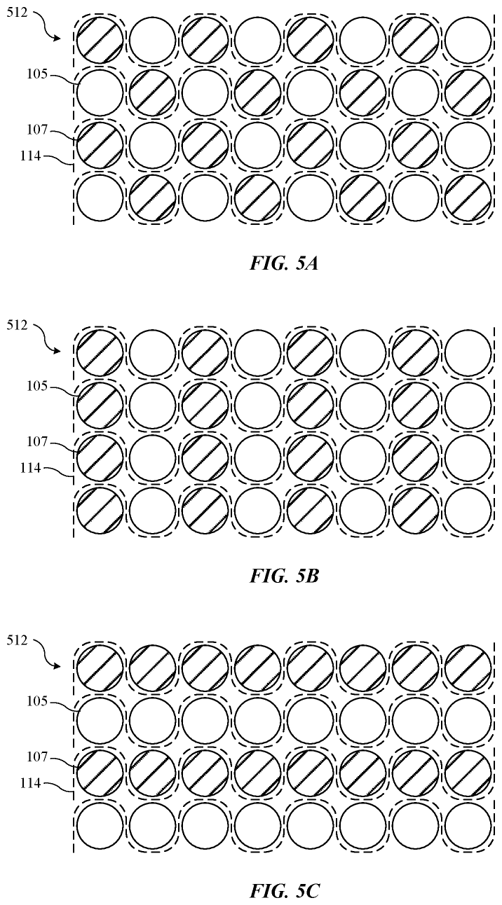

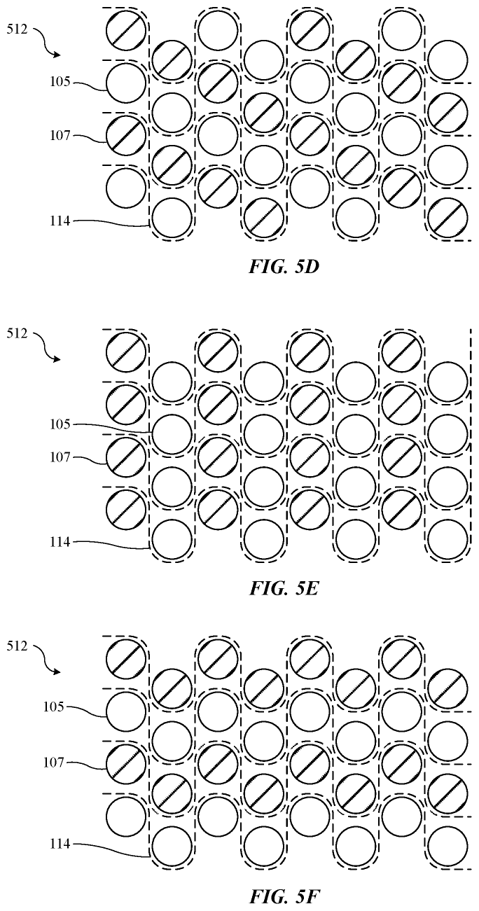

FIGS. 5A-5F show alternative arrangements of cells, including the first cells 105 and the second cells 107, a battery pack 512. In this implementation, the first cells 105 and the second cells 107 may be cylindrical cells, prismatic cells, of cells having another geometry capable of being arranged as shown. In FIGS. 5A-5C, the first cells 105 and the second cells 107 are arranged in an orthogonal grid. In FIG. 5A, the first cells 105 and the second cells 107 alternate in a checkerboard configuration that defines cell groups of like cell types on diagonals, with the cell type alternating with successive diagonals. In FIG. 5B the first cells 105 and the second cells 107 alternate by column, defining cell groups of like cell types along columns. In FIG. 5C, the first cells 105 and the second cells 107 alternate by row, defining cell groups of like cell types along rows. In FIGS. 5D-5F, the first cells 105 and the second cells 107 are arranged in a staggered configuration in which successive columns or rows are offset from adjacent ones. In FIG. 5D, the first cells 105 and the second cells 107 alternate by diagonals, with cell groups of like cell types alternating with successive diagonals. In FIG. 5B, the first cells 105 and the second cells 107 are arranged in an orthogonal grid, with the first cells 105 and the second cells 107 alternating by column, defining cell groups of like cell types along columns. In FIG. 5C, the first cells 105 and the second cells 107 are arranged in an orthogonal grid, with the first cells 105 and the second cells 107 alternating by row (the rows having a zig-zag offset pattern in this example), defining cell groups of like cell types along rows.

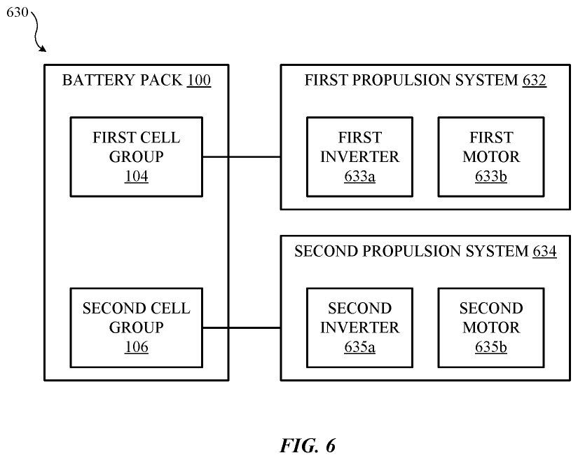

FIG. 6 is an illustration of a battery system 630 that includes the battery pack 100. In the battery system 630, the first group of cells 104 is not directly electrically connected to the second group of cells 106, for example, using configuration of the bus bars 112 described with respect to FIG. 4, including series connection of first cells 105 and separate series connection of the second cells 107. The battery system 630 is implemented in the context of a vehicle that includes a first propulsion system 632 and a second propulsion system 634. The first propulsion system 632 is powered by the first group of cells 104, and the second propulsion system 634 is powered by the second group of cells 106. The first group of cells 104 and the first propulsion system 632 may be electrically isolated from the second group of cells 106 and the second propulsion system 634 so that the first group of cells 104 is not able to power the second propulsion system 634 and so that the second group of cells 106 is not able to power the first propulsion system 632.

In the illustrated implementation, the first propulsion system 632 includes a first inverter 633a and a first electric motor 633b. The first inverter 633a receives electrical power from the first group of cells 104 and causes operation of the first electric motor 633b using the electrical power from the first group of cells 104. The second propulsion system 634 includes a second inverter 635a and a second electric motor 635b. The second inverter 635a receives electrical power from the second group of cells 106 and causes operation of the second electric motor 635b using the electrical power from the first group of cells 104.

The first inverter 633a and the second inverter 635a are each controlled to output alternating current electrical power (e.g., three-phase alternating current electrical power). The first inverter 633a uses direct current electrical power from the first group of cells 104 to generate a first alternating current output that is provided to the first electric motor 633b to cause operation of the first electric motor 633b. The second inverter 635a uses direct current electrical power from the second group of cells 104 to generate a second alternating current output that is provided to the second electric motor 635b to cause operation of the second electric motor 635b. The first propulsion system 632 and the second propulsion system 634 may be operated together to propel a vehicle, or may be operated separately to propel the vehicle. The first inverter 633a and the second inverter 635a may be implemented using conventional inverter designs. For example, the first inverter 633a and the second inverter 635a may be implemented using a switching-type inverter design that implements variable frequency drive to control speed and torque of the first electric motor 633b and the second electric motor 635b by varying the frequency and the voltage of the alternating current electrical power that is supplied to the first electric motor 633b and the second electric motor 635b.

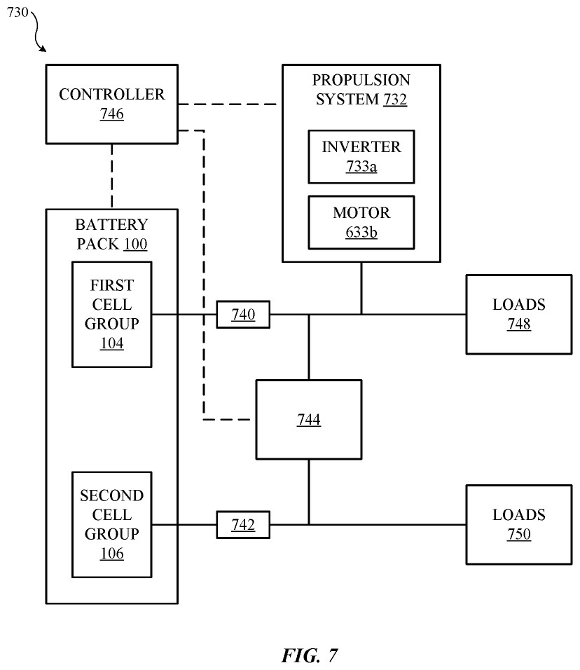

FIG. 7 is an illustration of a battery system 730 that includes the battery pack 100. In the battery system 730, the first group of cells 104 is not directly electrically connected to the second group of cells 106, for example, using configuration of the bus bars 112 described with respect to FIG. 4, including series connection of first cells 105 and separate series connection of the second cells 107. The battery system 630 may be implemented in the context of a vehicle that includes a propulsion system 732 including an inverter 733a and an electric motor 733b, which may be implemented in the manner described with respect to the first propulsion system 632, the first inverter 633a, and the first electric motor 633b.

The first group of cells 104 is connected to a first bus 740, and the second group of cells 106 is connected to a second bus 742. The first bus 740 and the second bus 742 are electrical power distribution structures that are configured to distribute power to various components. The first bus 740 and the second bus 742 include conductors and, optionally, other components that control distribution of power to various components that are connected to the first bus 740 and the second bus 742.

In the illustrated implementation, the propulsion system 732 is connected to the first bus 740 for direct supply of power from the first bus 740 to the propulsion system 732. As an example, power may be supplied from the first group of cells 104 to the inverter 733a of the propulsion system 732 without an intervening power convertor. The second group of cells 106 is not directly connected to the propulsion system 732. The second group of cells 106 is configured to supply power to the second bus 742. To allow the second group of cells 106 to supply power to the propulsion system 732 and/or to the first group of cells 104, the first bus 740 is connected to the second bus 742 by a DC-DC converter 744. Connection of the DC-DC converter 744 to the first bus 740 and the second bus 742 allows the DC-DC convertor to transfer power from the second bus 742 to the first bus 740, and optionally to transfer power from the first bus 740 to the second bus 742. The DC-DC convertor 744 may be configured to transfer power between the first group of cells 104 and the second group of cells 106, to allow charging of the first group of cells 104 using power from the second group of cells 106, or to allow charging of the second group of cells 106 using power from the first group of cells 104. The second group of cells 106 may be controllable to selectively provide power to the first group of cells104 through the DC-DC convertor 744 to charge the first group of cells 104 using power from the second group of cells 106, and the second group of cells 106 may be controllable to selectively provide power to the propulsion system 732 through the DC-DC converter 744 to cause operation of the propulsion system 732. As an example, the DC-DC converter 744 may be a bidirectional power converter that is configured to transfer electrical power between the first bus 740 and the second bus 742, while raising or lowering the voltage level between a first voltage level that is associated with the first group of cells 104 and the first bus 740 and a second voltage level that is associated with the second group of cells and the second bus 742. The first voltage level and the second voltage level may be different voltage levels or may be the same voltage level. The DC-DC converter 744 may be implemented using any suitable converter architecture, such as a switched-type converter architecture (e.g., implemented using transistors).

The DC-DC converter 744 is controllable, for example, by a controller 746 that is configured to regulate the direction of power transfer, the amount of power transfer, and the output current. The controller 746 may be a computer-implemented system, such as one including a processor, a memory, and instructions that are stored in the memory and configured to cause the processor to perform the functions described herein when execute. Other implementations of the controller 746 are possible, such as implementations using an application specific integrated circuit or a field programmable gate array. The controller 746 may also include or be connected to conventional components such as input devices, output devices, and communications devices.

The controller 746 may also be configured to control operation of the battery pack 100 and/or to control operation of the propulsion system 732. The controller 746 may be configured to control the DC-DC converter 744 and the battery pack 100 according to a first operation mode in which electrical power is supplied to the propulsion system 732 by the first group of cells 104, a second operation mode in which electrical power is supplied to the propulsion system 732 by the second group of cells 106 by transferring electrical power from the second bus 742 to the first bus 740, and a third mode of operation in which electrical power is supplied to the first group of cells 104 by the second group of cells 106 by transferring electrical power from the second bus 742 to the first bus 740 to charge the first group of cells 104.

Additional loads 748, 750 may also be connected to the first bus 740 and the second bus 742 to allow supply of power to the additional loads 748, 750 from the first bus 740 and the second bus 742, respectively. The additional loads 748, 750 may be supplied power at the voltage of the first bus 740 and the second bus 742, or may include a convertor to regulate supply of power and/or change the voltage.

The battery pack 100 may be implemented in a vehicle. The battery pack 100 supplies electrical power to some or all of the systems that are included in the vehicle. As an example, the vehicle may be a conventional road-going vehicle that includes a vehicle body and is supported by wheels. The vehicle may be, for example, a car, a truck, a motorcycle, a boat, or an aircraft. The vehicle may include a passenger compartment and/or a cargo compartment. The vehicle may include system that perform specific functions, such as a suspension system, a propulsion system, a braking system, a steering system, a sensing system, and a control system (e.g., manual or automated).

As described above, one aspect of the present technology is controlling a battery system, which may be implemented in a system that includes the gathering and use of data available from various sources. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to store user activity information that allows a power management system to control energy usage according to user preferences or user habits. Further, other uses for personal information data that benefit the user are also contemplated by the present disclosure. For example, location information and navigation information may be used as a basis for controlling the battery system.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, systems that use the present technology can be configured to allow users to select to “opt in” or “opt out” of participation in the collection of personal information data during registration for services or anytime thereafter. In another example, users can select not to provide personal information to services that use the present technology. In yet another example, users can select to limit the length of time personal information is maintained by services that use the present technology, or users may entirely prohibit use of personal information by systems that use the present technology. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A system, comprising:
a first group of cells having a first battery chemistry type;
a second group of cells having a second battery chemistry type; and
wherein cells from the first group of cells and cells from the second group of cells are arranged in an alternating manner in a first direction of a battery pack that includes the first group of cells and the second group of cells.

2. The system of claim 1, wherein at least one cell from the first group of cells is disposed between successive cells from the second group of cells in the first direction of the battery pack.

3. The system of claim 1, wherein each of the cells from the first group of cells and each of the cells from the second group of cells has a generally cuboidal configuration including a first broad surface that faces toward a first end of the battery pack, a second broad surface that faces toward a second end of the battery pack, a first side surface, a second side surface, a top surface and a bottom surface, and the first broad surfaces of the cells from the first group of cells face the second broad surfaces of adjacent ones of the cells from the second group of cells.

4. The system of claim 1, wherein the cells from the first group of cells have a lower volumetric energy density than the cells from the second group of cells.

5. The system of claim 1, wherein the cells from the first group of cells have a higher initiation temperature for a thermal event than the cells from the second group of cells.

6. The system of claim 1, wherein the cells from the first group of cells have a lower maximum temperature during a thermal event than the cells from the second group of cells.

7. The system of claim 1, wherein the cells from the first group of cells are lithium iron phosphate cells, and the cells from the second group of cells are at least one of nickel manganese cobalt cells or nickel cobalt aluminum oxide cells.

8. The system of claim 1, wherein the cells from the first group of cells are electrically connected in series with the cells from the second group of cells such that each of the cells from the first group of cells is directly electrically connected to a respective cell from the second group of cells.

9. The system of claim 1, wherein the cells from the first group of cells are electrically connected in series with each other, the cells from the second group of cells are electrically connected in series with each other, and the first group of cells is not directly electrically connected to the second group of cells.

10. The system of claim 9, further comprising:
a DC-DC converter that is configured to transfer power between the first group of cells and the second group of cells.

11. The system of claim 9, further comprising:
a propulsion system that is connected to the first group of cells and to the second group of cells, wherein the second group of cells is controllable to selectively provide power to the first group of cells to charge the first group of cells using power from the second group of cells, and the second group of cells is controllable to selectively provide power to the propulsion system to cause operation of the propulsion system.

12. The system of claim 1, further comprising:
a first group of bus bars that each electrically connect a respective pair of the cells from the first group of cells, each bus bar from the first group of bus bars extending past a respective one of the cells from the second group of cells; and
a second group of bus bars that each electrically connect a respective pair of the cells from the second group of cells, each bus bar from the second group of bus bars extending past a respective one of the cells from the first group of cells.

13. A system, comprising:
a battery pack having a first group of cells having a first battery chemistry type, and a second group of cells having a second battery chemistry type;
a first propulsion system that is powered by the first group of cells; and
a second propulsion system that is powered by the second group of cells.

14. The system of claim 13, wherein cells from the first group of cells and cells from the second group of cells are arranged in an alternating manner in a first direction of the battery pack.

15. The system of claim 13, further comprising:
a battery housing, wherein the first group of cells is disposed in the battery housing and the second group of cells is disposed in the battery housing.

16. The system of claim 13, wherein cells from the first group of cells have a lower volumetric energy density than cells from the second group of cells.

17. The system of claim 13, wherein cells from the first group of cells are lithium iron phosphate cells, and cells from the second group of cells are at least one of nickel manganese cobalt cells or nickel cobalt aluminum oxide cells.

18. The system of claim 13, wherein the first group of cells is not directly electrically connected to the second group of cells.

19. The system of claim 13, wherein the first propulsion system includes a first inverter that receives electrical power from the first group of cells and causes operation of a first electric motor using the electrical power from the first group of cells, and the second propulsion system includes a second inverter that receives electrical power from the second group of cells and causes operation of a second electric motor using the electrical power from the second group of cells.

20. A system, comprising:
a first bus;
a second bus;
a battery pack having a first group of cells having a first battery chemistry type, and a second group of cells having a second battery chemistry type, wherein the first group of cells is electrically connected to the first bus, and the second group of cells is electrically connected to the second bus; and
a DC-DC converter that is configured to transfer power between the first bus and the second bus.

21. The system of claim 20, further comprising:
a propulsion system that is connected to the first bus.

22. The system of claim 21, further comprising:
a controller that is configured to control the DC-DC converter and the battery pack according to a first operation mode in which electrical power is supplied to the propulsion system by the first group of cells, a second operation mode in which electrical power is supplied to the propulsion system by the second group of cells, and a third mode of operation in which electrical power is supplied to the first group of cells by the second group of cells to charge the first group of cells.

23. The system of claim 20, wherein cells from the first group of cells and cells from the second group of cells are arranged in an alternating manner in a first direction of the battery pack.

24. The system of claim 20, further comprising:
a battery housing, wherein the first group of cells is disposed in the battery housing and the second group of cells is disposed in the battery housing.

25. The system of claim 20, wherein cells from the first group of cells have a lower volumetric energy density than cells from the second group of cells.

26. The system of claim 20, wherein cells from the first group of cells are lithium iron phosphate cells, and cells from the second group of cells are at least one of nickel manganese cobalt cells or nickel cobalt aluminum oxide cells.
